(19) United States
(12) Patent Application Publication
(10) Pub. No.: US 2019/0146615 A1
(43) Pub. Date: May 16, 2019

(54) TOUCH DISPLAY SUBSTRATE AND TOUCH DISPLAY APPARATUS

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Bo Liu, Beijing (CN); Xianjie Shao, Beijing (CN); Honggang Gu, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/971,105

(22) Filed: May 4, 2018

(30) Foreign Application Priority Data
Nov. 13, 2017 (CN) 201711115441.6

(51) Int. Cl. G06F 3/047; G06F 3/044; G06F 3/041

(52) U.S. Cl. CPC G06F 3/047; G06F 3/044; G09G 2310/0264; G06F 2203/04112; G06F 3/0412

(57) ABSTRACT

A touch display substrate and a touch display apparatus are disclosed. The touch display substrate includes a base substrate with a display region and a lead-wire region, touch electrodes at the display region, trace lines at the display region and lead wires at the lead-wire region. The trace lines include touch-electrode wires and auxiliary wires. Each touch-electrode wire is coupled to corresponding touch electrode. Each auxiliary wire is not coupled to the touch electrodes and is in an area of an orthographic projection of one corresponding touch electrode to the base substrate. Within an area of an orthographic projection of each touch electrode to the base substrate, there are at least two trace lines. Each trace line is coupled to a touch signal output terminal of a driving circuit through one lead wire.

### CROSS-REFERENCE TO RELATED APPLICATION

This application is based on and claims the priority of the Chinese patent application No. 201711115441.6 filed on Nov. 13, 2017, which is incorporated herein by reference in its entirety.

### TECHNICAL FIELD

The present disclosure relates to the field of display technology, and in particular to a touch display substrate and a touch display apparatus.

### BACKGROUND

In a self-capacitive in-cell touch display apparatus, touch electrodes are usually block-shaped and reused as common electrodes. The touch electrodes are coupled to touch signal output terminals of a driving circuit through touch-electrode wires. Each touch electrode is corresponding to one touch-electrode wire. In a display time period, the driving circuit supplies a common voltage signal to the touch electrodes through the touch-electrode wires; in a touch time period, the driving circuit supplies a touch signal to the touch electrodes through the touch-electrode wires. In a region where the touch electrodes are, there is a plurality of pixel units. Each pixel unit includes three sub-pixel units including a red (R) sub-pixel unit, a green (G) sub-pixel unit and a blue (B) sub-pixel unit. The touch-electrode wire corresponding to each touch electrode is usually at one side of one column of pixel units in an area corresponding to each touch electrode. Since there is only one touch-electrode wire provided at one side of one column of pixel units in the area corresponding to each touch electrode, the trace lines are not distributed evenly, resulting in poor display uniformity of the touch display apparatus in the display time period and in the touch time period.

SUMMARY

A touch display substrate is provided and includes a base substrate with a display region and a lead-wire region, a plurality of touch electrodes at the display region, a plurality of trace lines at the display region and a plurality of lead wires at the lead-wire region. The plurality of trace lines include a plurality of touch-electrode wires and a plurality of auxiliary wires, each of the plurality of the touch-electrode wires is coupled to corresponding one of the plurality of touch electrodes, each of the plurality of auxiliary wires is not coupled to the plurality of touch electrodes and is in an area of an orthographic projection of the corresponding one of the plurality of touch electrodes to the base substrate. Within an area of an orthographic projection of each of the plurality of touch electrodes to the base substrate, there are at least two of the plurality of trace lines. Each of the plurality of trace lines is coupled to a touch signal output terminal of a driving circuit through one of the plurality of lead wires.

Optionally, the at least two of the plurality of trace lines within the area of the orthographic projection of each of the plurality of touch electrodes to the base substrate, include at least one of the plurality of touch-electrode wires and at least one of the plurality of auxiliary wires.

Optionally, the area of the orthographic projection of each of the plurality of touch electrodes to the base substrate is corresponding to at least two pixel unit partitions; the at least two pixel unit partitions are arranged along a direction perpendicular to an extension direction of the plurality of trace lines; each of the at least two pixel unit partitions includes a plurality of pixel units; the number of the plurality of pixel units in each of the at least two pixel unit partition is the same; each of the plurality of pixel units includes a plurality of sub-pixel units; each of the at least two pixel unit partitions is corresponding to at least one of the plurality of trace lines; the number of at least one of the plurality of trace lines corresponding to each of the at least two pixel unit partitions is the same; and the at least one of the plurality of trace lines corresponding to each of the at least two pixel unit partitions is at an identical position of each of the at least two pixel unit partitions.

Optionally, each of the at least two pixel unit partitions is corresponding to at least two of the plurality of trace lines; and one of the at least two of the plurality of trace lines is at an identical side of each of the at least two pixel unit partitions, and the other one of the at least two of the plurality of trace lines is between adjacent sub-pixel units of each of the at least two pixel unit partitions.

Optionally, each of the at least two pixel unit partitions includes one pixel unit along the direction perpendicular to the extension direction of the plurality of trace lines.

Optionally, one of the plurality of trace lines is at an identical side of each of the plurality of sub-pixel units.

Optionally, in each of the plurality of pixel units, the plurality of sub-pixel units and the plurality of trace lines are alternately arranged.

Optionally, a common voltage signal is supplied to the plurality of touch electrodes in a display time period and a touch signal is supplied to the plurality of touch electrodes in a touch time period.

Optionally, the lead-wire region is at a top side or a bottom side of the display region.

Optionally, the at least two of the plurality of trace lines within the area of the orthographic projection of each of the plurality of touch electrodes to the base substrate, include one of the plurality of touch-electrode wires and at least one of the plurality of auxiliary wires.

Optionally, the plurality of trace lines and the plurality of lead wires are in an identical layer.

A touch display apparatus is provided and includes the above touch display substrate.

Optionally, the touch display apparatus further includes a driving circuit with a plurality of touch signal output terminals that are coupled to the plurality of trace lines in a one-to-manner through the plurality of lead wires, respectively. The plurality of touch signal output terminals supply a common voltage signal to the plurality of trace lines in a display time period and supply a touch signal to the plurality of trace lines in a touch time period.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic view of a touch display substrate according to some embodiments of the present disclosure;

FIG. 2 is another schematic view of a touch display substrate according to some embodiments of the present disclosure;

FIG. 3 is still another schematic view of a touch display substrate according to some embodiments of the present disclosure; and

FIG. 4 is yet another schematic view of a touch display substrate according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The implementations set forth in the following description of exemplary embodiments do not represent all implementations consistent with the disclosure. Instead, they are merely examples of devices and methods consistent with aspects related to the disclosure as recited in the appended claims.

A touch display substrate is provided in some embodiments of the present disclosure. The touch display substrate includes a base substrate with a display region and a lead-wire region, a plurality of touch electrodes at the display region, a plurality of trace lines at the display region, and a plurality of lead wires at the lead-wire region. The trace lines include a plurality of touch-electrode wires and a plurality of auxiliary wires. The touch-electrode wires are connected with corresponding touch electrodes, respectively. The auxiliary wires are not connected with the touch electrodes. Within an area of an orthographic projection of each touch electrode to the base substrate, there are at least two trace lines. Each trace line is coupled to a touch signal output terminal of a driving circuit through one of the lead wires.

In one embodiment of the present disclosure, since there are at least two trace lines within the area of the orthographic projection of each touch electrode to the base substrate, the at least two trace lines can be distributed as evenly as possible in a region where the each touch electrode is, thereby solving the problem of uneven distribution of trace lines and then improving display uniformity of a touch display apparatus which includes the touch display substrate.

In some optional embodiments of the present disclosure, the at least two trace lines within the area of the orthographic projection of each touch electrode to the base substrate, includes at least one touch-electrode wire and at least one auxiliary wire.

The touch-electrode wire is electrically coupled to the corresponding touch electrode, and transmits a signal to the corresponding touch electrode. The auxiliary wire is not connected with the corresponding touch electrode. Although the auxiliary wire is not connected with the corresponding touch electrode, the auxiliary wire is still coupled to the touch signal output terminal of the driving circuit, thereby enabling touch signals to be evenly distributed in an area where all of the touch electrodes are. Optionally, each touch electrode is corresponding to only one touch-electrode wire. That is to say, in the at least two trace lines corresponding to each touch electrode, there is only one touch-electrode wire, and the rest includes one or more auxiliary wires. In other words, in some embodiments, each touch electrode is corresponding to at least one auxiliary wire as well as only one touch-electrode wire.

In some embodiments, the touch-electrode wires and the auxiliary wires are directly coupled to the touch signal output terminals of the driving circuit through the lead wires in the same lead-wire region, without providing a conductive pattern at a non-display region for connecting the auxiliary wires, thereby facilitating realizing narrow borders.

In some embodiments, the trace lines may be connected with the lead wires at the lead-wire region in a one-to-one manner. In other words, one trace line is corresponding to one lead wire. Of course, In other embodiments, the trace lines may also be coupled to the lead wires in other manners, for example, at least two trace lines corresponding to an identical touch electrode may be coupled to an identical lead wire, thereby reducing the number of the lead wires, and then further reducing an area of the lead-wire region and facilitating realizing narrow borders.

In some optional embodiments of the present disclosure, the base substrate of the touch display substrate includes a plurality of pixel units. Each pixel unit includes a plurality of sub-pixel units, such as a red (R) sub-pixel unit, a green (G) sub-pixel unit and a blue (B) sub-pixel unit. The region of the orthographic projection of each touch electrode to the base substrate corresponds to several pixel units. In order to enable the trace lines to be evenly distributed within the region corresponding to each touch electrode, in some embodiments, the several pixel units corresponding to one identical touch electrode may be divided into at least two pixel unit partitions in a direction perpendicular to an extension direction of the trace lines. The at least two pixel unit partitions are arranged side by side in the direction perpendicular to then extension direction of the trace lines. Each pixel unit partition includes a plurality of pixel units. The number of pixel units in each pixel unit partition is the same. Each pixel unit partition corresponds to at least one trace line. The number of trace lines corresponding to each pixel unit partition is the same. A position of each trace line in the corresponding pixel unit partition is the same. Since the number of trace lines corresponding to each pixel unit partition is the same and the position of each trace line in the corresponding pixel unit partition is the same, the distribution of the trace lines is uniform.

In some optional embodiments of the present disclosure, each pixel unit partition corresponds to one trace line. Further, the trace line may be at an identical side of each pixel unit partition. For example, each pixel unit partition corresponds to one trace line, and the trace line is at a left side or a right side of each pixel unit partition. In other words, one trace line is provided at an identical position of each pixel unit partition, thereby enabling distribution of the trace lines to be uniform.

For example, each pixel unit includes three sub-pixels including R, G and B sub-pixel. The three sub-pixels are arranged in a row direction. Within the region of the orthographic projection of each touch electrode to the base substrate, there are 90 sub-pixels in the row direction, i.e., 30 pixel units, and there are 20 sub-pixels in a column direction. The 30 pixel units in the row direction may be divided into 6 pixel unit partitions, and each pixel unit partition includes 5 pixel units in the row direction. One trace line may be provided at an identical side of each pixel unit partition. Then, within the region of the orthographic projection of each touch electrode to the base substrate, there are 5 trace lines, and the number of pixel units corresponding to each trace line (i.e., the number of pixel units at two sides of each trace line) is the same, thereby improving display uniformity of a touch display apparatus which includes the touch display substrate.

In some optional embodiments of the present disclosure, each pixel unit partition corresponds to at least two trace lines. One of the at least two trace lines is provided at an identical side of each pixel unit partition, and the rest is disposed between adjacent sub-pixel units in each pixel unit partition.

In some optional embodiments of the present disclosure, each pixel unit partition includes one pixel unit in a direction perpendicular to an extension direction of the trace lines. Then, each pixel unit is corresponding to one trace line in the direction perpendicular to the extension direction of the trace lines, and thus the trace lines can be distributed evenly.

Further, optionally, each pixel unit corresponds to one trace line. The trace line may be at an identical side of each pixel unit and thus the trace lines can be distributed evenly.

Further, optionally, one trace line is disposed at an side of each sub-pixel unit, and thus each sub-pixel unit corresponds to one trace line. Then, the trace lines can be distributed evenly.

In some optional embodiments of the present disclosure, a common voltage signal is supplied to the touch electrodes in a display time period and a touch signal is supplied to the touch electrodes in a touch time period. In other words, the touch electrodes are reused as common electrodes.

Optionally, the touch electrodes are block-shaped.

In some optional embodiments of the present disclosure, the touch electrodes may be self-capacitive touch electrodes or mutual-capacitive touch electrodes. When the touch electrodes are the mutual-capacitive touch electrodes, may be used as touch driving electrodes in the mutual-capacitive touch electrodes.

In some optional embodiments of the present disclosure, the touch display substrate further includes a plurality of data lines. Optionally, the tacks and the data lines may be parallel to each other, and they may be in an identical layer and made of the same material. In other words, the trace lines and data are designed to be arranged side by side. Further, the trace lines and the lead wires may be in an identical layer and made of the same material. In this way, the touch-electrode wires and the lead wires are in an identical layer, and they be directly connected to each other.

In some optional embodiments of the present disclosure, the lead-wire region is at a top side or a bottom side of the display region, thereby facilitating realizing narrow borders.

The touch display substrate of some optional embodiments of the present disclosure will be described in details hereinafter in conjunction embodiments.

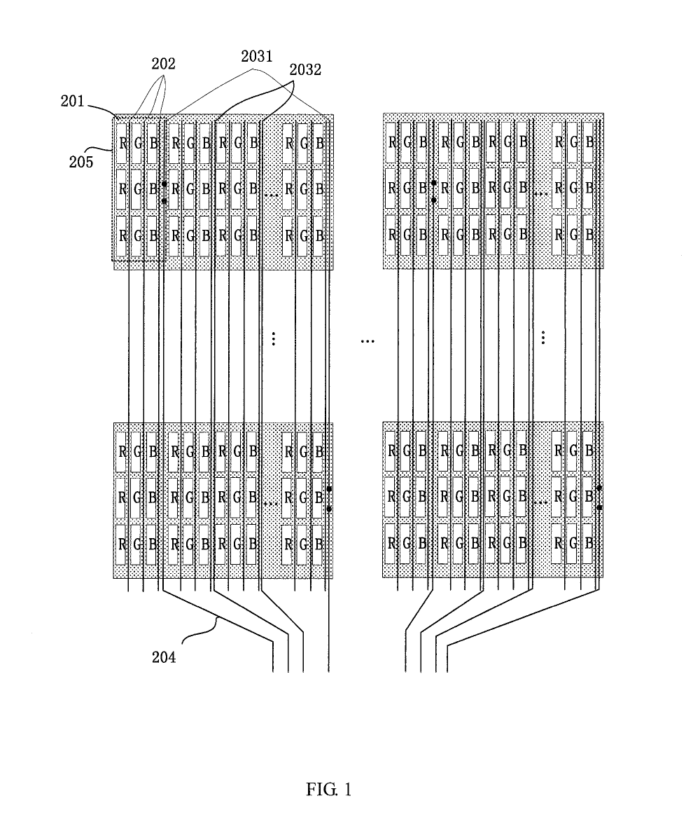

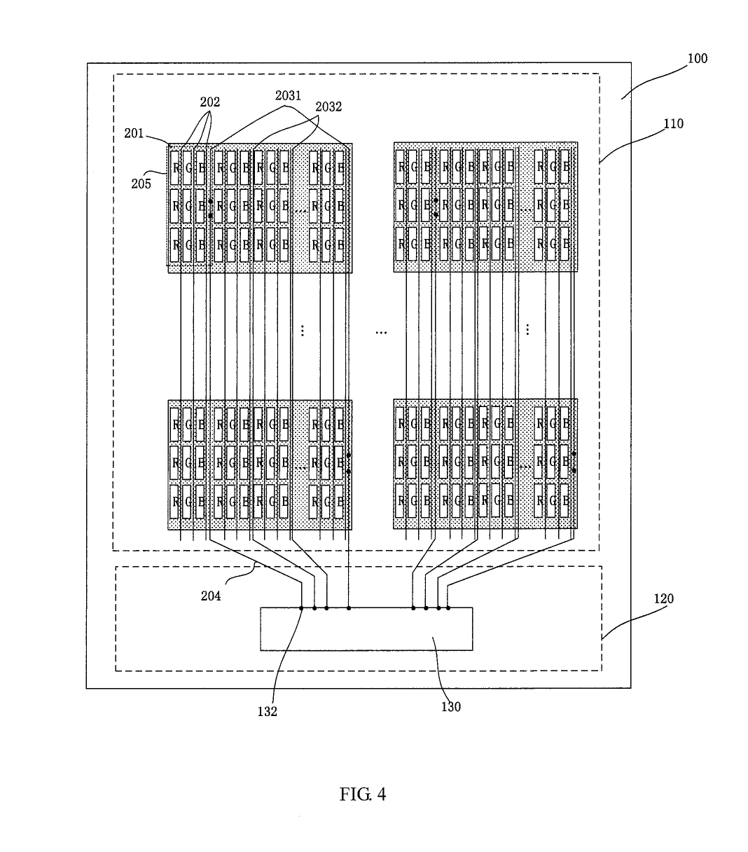

FIG. 1 and FIG. 4 are schematic views of a touch display substrate according to some embodiments of the present disclosure. Referring to FIG. 1 and FIG. 4, the touch display substrate includes a base substrate 100. The base substrate 100 has a display region 110 and a lead-wire region 120. The touch display substrate further includes a plurality of touch electrodes 201 at the display region 110, a plurality of trace lines at the display region 110, a plurality of data lines 202 and a plurality of pixel units.

The tacks and the data lines 202 may be parallel to each other, and they may be in an identical layer and made of the same material. Within an area of an orthographic projection of each touch electrode 201 to the base substrate 100, there is a plurality of trace lines. The plurality of trace lines corresponding to each touch electrode 201 include a touch-electrode wire 2031 connected with the each touch electrode 201, and a plurality of auxiliary wires 2032 that are not connected with the each touch electrode 201. There is a plurality of lead wires 204 in the lead-wire region 120. The trace lines are connected with the lead wires 204 in a one-to-one manner, and the trace lines are coupled to touch signal output terminals 132 of a driving circuit 130 through the lead wires.

Each pixel unit includes a red (R) sub-pixel unit, a green (G) sub-pixel unit and a blue (B) sub-pixel unit. The region of the orthographic projection of each touch electrode 201 to the base substrate 100 corresponds to several pixel units. In some embodiments, the several pixel units corresponding to one identical touch electrode may be divided into a plurality of pixel unit partitions 205 (for example, one pixel unit partition 205 is shown in a dotted box shown in FIG. 1) in a row direction. Each pixel unit partition 205 includes one pixel unit in the row direction. Each pixel unit partition 205 corresponds to one trace line (i.e., one touch-electrode wire 2031 or one auxiliary wire 2032). A position of each trace line in the corresponding pixel unit partition 205 is the same, for example, the trace line is at the right side of each pixel unit partition 205.

In some optional embodiments of the present disclosure, one trace line is provided at an identical position of each pixel unit partition, thereby enabling distribution of the trace lines to be uniform and then improving display uniformity of a touch display apparatus which includes the touch display substrate.

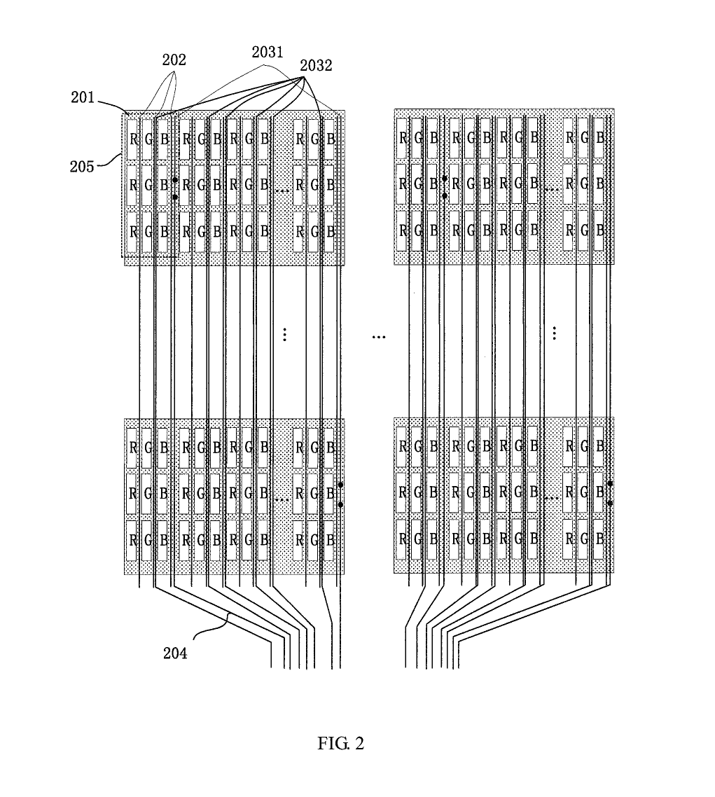

FIG. 2 is a schematic view of a touch display substrate according to some embodiments of the present disclosure. Referring to FIG. 2, the touch display substrate includes a base substrate 100 (referring to FIG. 4). The base substrate 100 has a display region 110 (referring to FIG. 4) and a lead-wire region 120 (referring to FIG. 4). The touch display substrate further includes a plurality of touch electrodes 201 at the display region 110, a plurality of trace lines at the display region 110, a plurality of data lines 202 and a plurality of pixel units.

The tacks and the data lines 202 may be parallel to each other, and they may be in an identical layer and made of the same material. Within an area of an orthographic projection of each touch electrode 201 to the base substrate 100, there is a plurality of trace lines. The plurality of trace lines corresponding to each touch electrode 201 include a touch-electrode wire 2031 connected with the each touch electrode 201, and a plurality of auxiliary wires 2032 that are not connected with the each touch electrode 201. There is a plurality of lead wires 204 in the lead-wire region 120. The trace lines are connected with the lead wires 204 in a one-to-one manner, and the trace lines are coupled to touch signal output terminals 132 of a driving circuit 130 through the lead wires.

Each pixel unit includes a red (R) sub-pixel unit, a green (G) sub-pixel unit and a blue (B) sub-pixel unit. The region of the orthographic projection of each touch electrode 201 to the base substrate 100 corresponds to several pixel units. In some embodiments, the several pixel units corresponding to one identical touch electrode may be divided into a plurality of pixel unit partitions 205 (for example, one pixel unit partition 205 is shown in a dotted box shown in FIG. 1) in a row direction. Each pixel unit partition 205 includes one pixel unit in the row direction. Each pixel unit partition 205 corresponds to two trace lines. One of the two trace lines is at a right side of the each pixel unit partition 205, and the other one of the two trace lines is between adjacent sub-pixel units of the each pixel unit partition 205, for example, between the green sub-pixel unit and the blue sub-pixel unit.

In some optional embodiments of the present disclosure, two trace lines are provided at two identical positions of each pixel unit partition, thereby enabling distribution of the trace lines to be uniform and then improving display uniformity of a touch display apparatus which includes the touch display substrate.

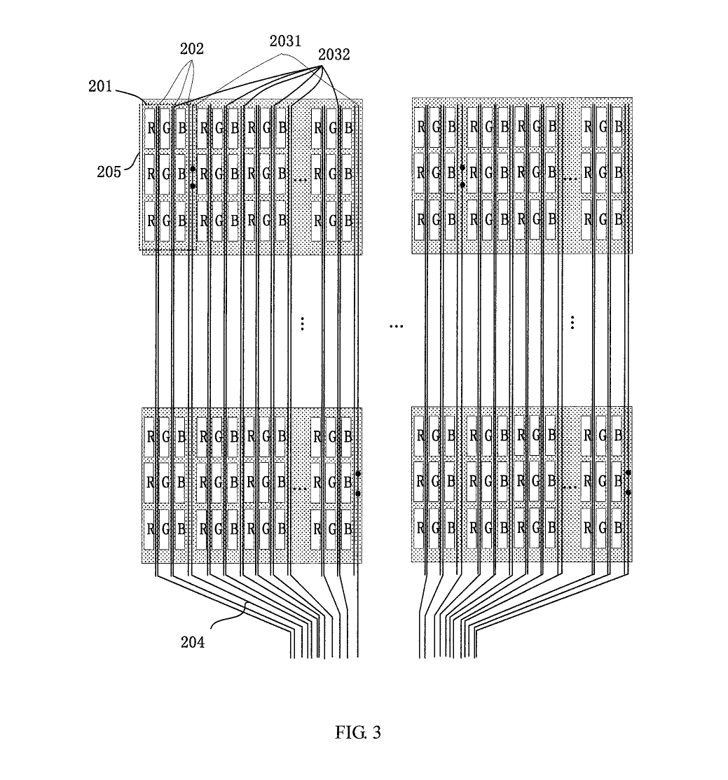

FIG. 3 is a schematic view of a touch display substrate according to some embodiments of the present disclosure. Referring to FIG. 3, the touch display substrate includes a base substrate 100 (referring to FIG. 4). The base substrate 100 has a display region 110 (referring to FIG. 4) and a lead-wire region 120 (referring to FIG. 4). The touch display substrate further includes a plurality of touch electrodes 201 at the display region 110, a plurality of trace lines at the display region 110, a plurality of data lines 202 and a plurality of pixel units.

The tacks and the data lines 202 may be parallel to each other, and they may be in an identical layer and made of the same material. Within an area of an orthographic projection of each touch electrode 201 to the base substrate 100, there is a plurality of trace lines. The plurality of trace lines corresponding to each touch electrode 201 include a touch-electrode wire 2031 connected with the each touch electrode 201, and a plurality of auxiliary wires 2032 that are not connected with the each touch electrode 201. There is a plurality of lead wires 204 in the lead-wire region 120. The trace lines are connected with the lead wires 204 in a one-to-one manner, and the trace lines are coupled to touch signal output terminals 132 of a driving circuit 130 through the lead wires.

Each pixel unit includes a red (R) sub-pixel unit, a green (G) sub-pixel unit and a blue (B) sub-pixel unit. The region of the orthographic projection of each touch electrode 201 to the base substrate 100 corresponds to several pixel units. In some embodiments, the several pixel units corresponding to one identical touch electrode may be divided into a plurality of pixel unit partitions 205 (for example, one pixel unit partition 205 is shown in a dotted box shown in FIG. 1) in a row direction. Each pixel unit partition 205 includes one pixel unit in the row direction. Each pixel unit partition 205 corresponds to three trace lines. One trace line is at a side of each sub-pixel unit.

In some optional embodiments of the present disclosure, one trace line is provided at one side of each sub-pixel unit, thereby enabling distribution of the trace lines to be uniform and then improving display uniformity of a touch display apparatus which includes the touch display substrate.

A touch display apparatus is provided according to some embodiments of the present disclosure, and includes the above touch display substrate.

The touch display apparatus may be a touch display panel, or a touch device which includes a touch display panel and a driving circuit.

When the touch display apparatus includes a driving circuit 130 (as shown in FIG. 4), the driving circuit 130 includes a plurality of touch signal output terminals 132. Optionally, the touch signal output terminals 132 are coupled to the touch-electrode wires in a one-to-one manner through the lead wires.

In some optional embodiments of the present disclosure, the driving circuit supplies a common voltage signal to the trace lines in a display time period and supplies a touch signal to the tacks in a touch time period.

Unless otherwise defined, any technical or scientific terms used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than being limited to physical or mechanical connection. Such words as “on/above”, “under/below”, “left” and “right” are merely used to represent relative position relationship, and when an absolute position of an object is changed, the relative position relationship will be changed too.

The above are merely the optionally embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

What is claimed is:

1. A touch display substrate comprising:
a base substrate with a display region and a lead-wire region;
a plurality of touch electrodes at the display region;
a plurality of trace lines at the display region; and
a plurality of lead wires at the lead-wire region;
wherein the plurality of trace lines include a plurality of touch-electrode wires and a plurality of auxiliary wires; each of the plurality of the touch-electrode wires is coupled to corresponding one of the plurality of touch electrodes; each of the plurality of auxiliary wires is not coupled to the plurality of touch electrodes and is in an area of an orthographic projection of the corresponding one of the plurality of touch electrodes to the base substrate; and
wherein within an area of an orthographic projection of each of the plurality of touch electrodes to the base substrate, there are at least two of the plurality of trace lines; and each of the plurality of trace lines is coupled to a touch signal output terminal of a driving circuit through one of the plurality of lead wires.

2. The touch display substrate of claim 1, wherein the at least two of the plurality of trace lines within the area of the orthographic projection of each of the plurality of touch electrodes to the base substrate, include at least one of the plurality of touch-electrode wires and at least one of the plurality of auxiliary wires.

3. The touch display substrate of claim 1, wherein the area of the orthographic projection of each of the plurality of touch electrodes to the base substrate is corresponding to at least two pixel unit partitions; the at least two pixel unit partitions are arranged along a direction perpendicular to an extension direction of the plurality of trace lines; each of the at least two pixel unit partitions includes a plurality of pixel units; the number of the plurality of pixel units in each of the at least two pixel unit partition is the same; each of the plurality of pixel units includes a plurality of sub-pixel units; each of the at least two pixel unit partitions is corresponding to at least one of the plurality of trace lines; the number of at least one of the plurality of trace lines corresponding to each of the at least two pixel unit partitions is the same;
and the at least one of the plurality of trace lines corresponding to each of the at least two pixel unit partitions is at an identical position of each of the at least two pixel unit partitions.

4. The touch display substrate of claim 3, wherein each of the at least two pixel unit partitions is corresponding to at least two of the plurality of trace lines; and one of the at least two of the plurality of trace lines is at an identical side of each of the at least two pixel unit partitions, and the other one of the at least two of the plurality of trace lines is between adjacent sub-pixel units of each of the at least two pixel unit partitions.

5. The touch display substrate of claim 3, wherein each of the at least two pixel unit partitions includes one pixel unit along the direction perpendicular to the extension direction of the plurality of trace lines.

6. The touch display substrate of claim 3, wherein one of the plurality of trace lines is at an identical side of each of the plurality of sub-pixel units.

7. The touch display substrate of claim 3, wherein in each of the plurality of pixel units, the plurality of sub-pixel units and the plurality of trace lines are alternately arranged.

8. The touch display substrate of claim 1, wherein a common voltage signal is supplied to the plurality of touch electrodes in a display time period and a touch signal is supplied to the plurality of touch electrodes in a touch time period.

9. The touch display substrate of claim 1, wherein the lead-wire region is at a top side or a bottom side of the display region.

10. The touch display substrate of claim 1, wherein the at least two of the plurality of trace lines within the area of the orthographic projection of each of the plurality of touch electrodes to the base substrate, include one of the plurality of touch-electrode wires and at least one of the plurality of auxiliary wires.

11. The touch display substrate of claim 1, wherein the plurality of trace lines and the plurality of lead wires are in an identical layer.

12. A touch display apparatus comprising the touch display substrate of claim 1.

13. The touch display apparatus of claim 12, further comprising: a driving circuit with a plurality of touch signal output terminals that are coupled to the plurality of trace lines in a one-to-manner through the plurality of lead wires, respectively;
wherein the plurality of touch signal output terminals supply a common voltage signal to the plurality of trace lines in a display time period and supply a touch signal to the plurality of trace lines in a touch time period.
